(19) United States
(12) Patent Application Publication
(10) Pub. No.: US 2017/0044049 A1
(43) Pub. Date: Feb. 16, 2017

(54) GLASS

(71) Applicant: ASAHI GLASS COMPANY, LIMITED, Chiyoda-ku (JP)

(72) Inventors: Shuji YAMAZAKI, Tokyo (JP); Shusaku AKIBA, Tokyo (JP); Kenji KITAOKA, Tokyo (JP)

(73) Assignee: ASAHI GLASS COMPANY, LIMITED, Chiyoda-ku (JP)

(21) Appl. No.: 15/336,055

(22) Filed: Oct. 27, 2016

Related U.S. Application Data
(63) Continuation of application No. PCT/JP2015/062548, filed on Apr. 24, 2015.

(30) Foreign Application Priority Data
Apr. 30, 2014 (JP) 2014-094050

(51) Int. Cl. C03C 3/093; G06F 3/041; C03C 4/18

(52) U.S. Cl. CPC C03C 3/093; C03C 4/18; G06F 3/041; C03C 2204/00

(57) ABSTRACT

A glass includes, as represented by mole percentage based on the following oxides, from 56 to 72% of SiO₂, from 3 to 20% of B₂O₃, from 8 to 20% of Al₂O₃, from 8 to 25% of Na₂O, from 0 to 5% of K₂O, from 0 to 15% of MgO, from 0 to 5% of CaO, from 0 to 3% of SrO, from 0 to 3% of BaO, and from 0.1 to 8% of ZrO₂. The glass contains substantially no Li₂O.

### TECHNICAL FIELD

The present invention relates to a glass and a chemically strengthened glass obtained therefrom.

### BACKGROUND ART

In recent years, information appliances mainly include a touch panel display, such as tablet PCs, smartphones, and electronic book readers. The touch panel display has a structure composed of a glass substrate for display and, a touch sensor glass and a cover glass that are superposed thereon. There also is a member which is configured of a touch sensor glass and a cover glass united therewith and which is called OGS (one-glass solution).

The touch sensor glass, cover glass, and glass of OGS each are required to be thin and have high strength, and chemically strengthened glasses which have undergone a chemical strengthening treatment with ion exchange are used as such glasses.

The enhanced properties of these chemically strengthened glasses are generally expressed by surface compressive stress (CS; compressive stress) and compressive stress depth (DOL; depth of layer). In a case where an ordinary soda-lime glass, as a raw glass sheet, is subjected to a chemical strengthening treatment, a chemically strengthened glass having a CS of 500 to 600 MPa and a DOL of 6 to 10 m is generally obtained.

An aluminosilicate glass having a composition which facilitates ion exchange has been proposed in order to attain higher strength than soda-lime glasses. In a case where the aluminosilicate glass, as a raw glass sheet, is subjected to a chemical strengthening treatment, a chemically strengthened glass having a CS of 700 to 850 MPa and a DOL of 20 to 100 μm is obtained.

Low brittleness and high hardness are important for the cover glasses required to have high strength. It has been reported that in the aluminosilicate glasses, increasing the hardness results in increased brittleness and a high tendency to crack (Non-Patent Document 1).

Meanwhile, it is conventional that a glass composition which attains low brittleness is obtained by incorporating boric acid to configure an aluminoborosilicate glass, but this glass is lower in hardness than the aluminosilicate glass (Patent Document 1). Namely, low brittleness and high hardness are inconsistent with each other, and it has been difficult to enable a glass to combine these two properties on a high level.

Surface compressive stress, in a chemical strengthening treatment, is introduced by ion exchange and the stress undergoes relaxation due to a heat treatment performed during the chemical strengthening. It is hence conventional that the value of surface compressive stress is determined by an interaction between these. Because of this, glasses which are considerably affected by the thermal stress relaxation do not have a high value of compressive stress, and it has been difficult with such glasses to improve production efficiency by elevating the temperature for chemical strengthening treatment (Patent Document 2).

### PRIOR ART DOCUMENTS

### Patent Documents

Patent Document 1: JP-A-2011-213576
Patent Document 2: JP-A-2012-148955

### Non-Patent Document

Non-Patent Document 1: Satoshi Yoshida, Atsuo Hidaka and Jun Matsuoka, Journal of Non-Crystalline Solids, Vol. 344, Issue 1-2, (2004), pp. 37-43

### SUMMARY OF THE INVENTION

### Problem that the Invention is to Solve

Consequently, an object of the present invention is to provide a glass capable of having both of low brittleness and high hardness, which are properties inconsistent to each other, on a high level. That is, an object thereof is to provide a glass in which the hardness of aluminoborosilicate glasses has been improved and which suffers only a slight decrease in surface compressive stress (CS) due to stress relaxation during chemical strengthening, and to provide a chemically strengthened glass obtained by chemically strengthening the glass.

### Means for Solving the Problem

The present inventors found that the problem can be overcome by a glass having a specific composition, and have completed the present invention.

That is, the present invention is as follows.

1. A glass comprising, as represented by mole percentage based on the following oxides, from 56 to 72% of SiO₂, from 3 to 20% of B₂O₃, from 8 to 20% of Al₂O₃, from 8 to 25% of Na₂O, from 0 to 5% of K₂O, from 0 to 15% of MgO, from 0 to 5% of CaO, from 0 to 3% of SrO, from 0 to 3% of BaO, and from 0.1 to 8% of ZrO₂ and containing substantially no Li₂O.

2. The glass according to the above item 1, wherein the following relationship using contents of respective components is satisfied: 0.05<ZrO₂/(B₂O₃+ZrO₂)<0.45.

3. The glass according to the above item 1 or 2, wherein the following relationship using contents of respective components is satisfied: 0.01<ZrO₂/(B₂O₃+R₂O+R′O+Al₂O₃)<0.07 (where R is at least one member selected from the group consisting of Na and K, and R′ is at least one member selected from the group consisting of Mg, Ca, Sr, and Ba).

4. The glass according to any one of the above items 1 to 3, wherein as viscosity properties of the glass, when a viscosity slope from a temperature (T2) at which the glass has a viscosity of 10² dPa·s to a temperature (softening point: T7.65) at which the glass has a viscosity of 10^{7.65} dPa·s is multiplied by the T2, the resultant product {5.65/(T2-T7.65)}×T2 (expression 1) is 11 or larger, and the T2 is 1,850° C. or lower and the softening point is 800° C. or higher.

5. The glass according to any one of the above items 1 to 4, which has been produced by a float process.

6. The glass according to any one of the above items 1 to 5, which can be chemically strengthened.

7. A chemically strengthened glass obtained by chemically strengthening the glass according to the above item 6, the chemically strengthened glass having in a surface thereof at least one member selected from the group consisting of a sodium ion, a silver ion, a potassium ion, a cesium ion, and a rubidium ion, and having a surface compressive stress of at least 700 MPa and having a surface compressive stress layer having a depth of at least 20 μm.

8. The chemically strengthened glass according to the above item 7, which has a specific gravity of less than 2.48.

9. A cover glass comprising the chemically strengthened glass according to the above item 7 or 8.

10. A display device comprising the cover glass according to the above item 9.

11. A touch panel comprising a glass substrate on which an electrode for detecting an input position has been formed, the glass substrate comprising either the chemically strengthened glass according to the above item 7 or 8 or the cover glass according to the above item 9.

### Advantageous Effects of the Invention

In the glass of the present invention, an aluminoborosilicate glass contains, as represented by mole percentage based on oxides, 3% or more and 20% or less of B₂O₃ and 0.1% or more and 8% or less of ZrO₂ and contains substantially no Li₂O. Due to this composition, the aluminoborosilicate glass can have improved hardness and the decrease in surface compressive stress (CS) therein due to stress relaxation during chemical strengthening can be rendered small.

### MODES FOR CARRYING OUT THE INVENTION

The present invention is explained below in detail.

### <Glass>

The glass of the present invention includes, as represented by mole percentage based on oxides, from 56 to 72% of SiO₂, from 3 to 20% of B₂O₃, from 8 to 20% of Al₂O₃, from 8 to 25% of Na₂O, from 0 to 5% of K₂O, from 0 to 15% of MgO, from 0 to 5% of CaO, from 0 to 3% of SrO, from 0 to 3% of BaO, and from 0.1 to 8% of ZrO₂ and contains substantially no Li₂O.

The reasons why the glass composition has been limited to the one shown above in the glass of the present invention are explained below. In this description, the mere expression “%” means “% by mole” unless otherwise indicated.

SiO₂ is a component which constitutes the framework of the glass, and is essential. SiO₂ is also a component which reduces cracking when a flaw (indentation) has been formed on the glass surface or which reduces the breakage rate when an indentation is made after chemical strengthening. In a case where the content of SiO₂ is 56% or higher, the glass can be prevented from decreasing in stability, acid resistance, weatherability, or chipping resistance. The content of SiO₂ is preferably 58% or higher, more preferably 60% or higher. In a case where the content of SiO₂ is 75% or less, the glass can be prevented from increasing in viscosity to have reduced meltability. The SiO₂ content is preferably 72% or less, more preferably 70% or less.

Al₂O₃ is a component which is effective in improving the ion-exchange performance and chipping resistance or which heightens the surface compressive stress. Al₂O₃ hence is essential. In a case where the content of Al₂O₃ is 8% or higher, a desired value of surface compressive stress or a desired compressive-stress layer thickness is obtained through ion exchange. The Al₂O₃ content is preferably 9% or higher, more preferably 10% or higher, even more preferably 11% or higher. In a case where the content of Al₂O₃ is 20% or less, the glass can be prevented from increasing in viscosity and be melted evenly or a decrease in acid resistance can be avoided. The content of Al₂O₃ is preferably 18% or less, more preferably 16% or less, even more preferably 15% or less.

B₂O₃ is a component which mitigates the brittleness and reduces the breakage rate when a Vickers indentation is made after chemical strengthening or which improves the high-temperature meltability. B₂O₃ hence is essential. The content of B₂O₃ is preferably 3% or higher, more preferably 4% or higher. Meanwhile, in a case where the content of B₂O₃ is 20% or less, a homogeneous glass can be obtained or a decrease in weatherability can be avoided. The content of B₂O₃ is preferably 15% or less, more preferably 10% or less, even more preferably 8% or less, especially preferably 7% or less.

Na₂O is a component which causes the glass to form a surface compressive stress layer through ion exchange and which improves the meltability of the glass.

Na₂O hence is essential. In a case where the content of Na₂O is 8% or higher, a desired surface compressive stress layer can be formed through ion exchange. The Na₂O content is preferably 10% or higher, more preferably 12% or higher, even more preferably 13% or higher. In a case where the content of Na₂O is 25% or less, a decrease in weatherability or acid resistance can be avoided or cracking from an indentation can be avoided. The content of Na₂O is preferably 20% or less, more preferably 18% or less.

K₂O is not essential, but heightens the rate of ion exchange. K₂O may hence be contained in an amount of up to 5%. In a case where the content of K₂O is 5% or less, cracking from an indentation can be avoided or the surface compressive stress can be prevented from changing considerably with the concentration of NaNO₃ in molten potassium nitrate. The content of K₂O is preferably 3% or less, more preferably 1% or less. In a case where it is desired to reduce the change in surface compressive stress due to the concentration of NaNO₃ in the molten potassium nitrate, it is preferable that the glass should contain no K₂O.

MgO is not essential, but is a component which heightens the surface compressive stress and improves the meltability. MgO may hence be contained in an amount up to 15%. In a case where the content of MgO is 15% or less, the glass can be prevented from devitrifying or from decreasing in ion-exchange rate. The content of MgO is preferably 10% or less, more preferably 8% or less, even more preferably 5% or less.

CaO improves the high-temperature meltability or renders the glass less apt to devitrify. CaO may hence be contained in an amount up to 5%. In a case where the content of CaO is 5% or less, a decrease in ion-exchange rate or decrease in resistance to cracking can be avoided. The content of CaO is preferably 3% or less, more preferably 1% or less. Typically, the glass contains no CaO.

SrO may be contained according to need. However, since SrO is more effective in lowering the rate of ion exchange than MgO and CaO, it is preferable that the content of SrO, if it is contained, should be 3% or less. Typically, the glass contains no SrO.

BaO is most effective in lowering the rate of ion exchange among the oxides of the alkaline earth metals. It is therefore preferable that the glass should contain no BaO or contain BaO in an amount of 3% or less.

In a case where the glass contains SrO and/or BaO, the total content thereof is preferably 1% or less, more preferably less than 0.3%.

In a case where the glass contains at least one of CaO, SrO, and BaO, the total content of these three components is preferably less than 3%. In a case where the total content thereof is less than 3%, a decrease in ion-exchange rate can be avoided. Typically, the content thereof is 1% or less.

ZrO₂ is a component which improves the hardness or elevates the softening point to reduce stress relaxation or which improves the acid resistance. ZrO₂ hence is essential. In a case where the content of ZrO₂ is 0.1% or higher, the surface compressive stress is prevented from being relaxed too much during ion exchange or during subsequent heat treatment and a desired value of surface compressive stress can be obtained. The content of ZrO₂ is preferably 0.1% or higher, more preferably 0.3% or higher, even more preferably 0.5% or higher. In a case where the content of ZrO₂ is 8% or less, cracking from an indentation or an increase in devitrification temperature can be avoided. The content of ZrO₂ is preferably 5% or less, more preferably 3% or less, even more preferably 2% or less.

Li₂O is a component which excessively lowers the strain point and low-temperature viscosity to render stress relaxation prone to occur, undesirably resulting in a decrease in the stress value of the compressive stress layer. It is therefore preferable that the glass should contain substantially no Li₂O. The expression “contain substantially no Li₂O” means that the content thereof is approximately on an impurity level. The content of Li₂O is preferably less than 0.05%, more preferably less than 0.01%.

Furthermore, there are cases where the Li₂O dissolves out in the molten salt, e.g., KNO₃, during a chemical strengthening treatment, and a chemical strengthening treatment performed with such Li-containing molten salt results in a considerable decrease in surface compressive stress. From this standpoint also, it is preferable that the glass should contain no Li₂O.

The glass may further contain chlorides, fluorides, and the like as clarifying agents for glass melting. Although the glass of the present invention is essentially constituted of the components explained above, the glass may contain other components unless the inclusion thereof defeats the object of the present invention. In a case where the glass contains such components, the total content of these components is preferably 5% or less, more preferably 3% or less, typically 1% or less.

In the glass of the present invention, the value of ZrO₂/(B₂O₃+ZrO₂) which governs the hardness and brittleness of the glass is preferably larger than 0.05, more preferably 0.08 or larger, even more preferably 0.10 or larger, and is preferably less than 0.45, more preferably 0.4 or less, even more preferably 0.35 or less. By regulating the value thereof so as to be larger than 0.05, the glass can be prevented from having a lower hardness than aluminoborosilicate glasses. By regulating the value thereof so as to be less than 0.45, the glass can be prevented from being embrittled by an increase in specific gravity.

In the glass of the present invention, the value of ZrO₂/(B₂O₃+R₂O+R′O+Al₂O₃) (where R is at least one member selected from the group consisting of Na and K, and R′ is at least one member selected from the group consisting of Mg, Ca, Sr, and Ba), which governs the hardness and brittleness of glass, is preferably larger than 0.01, more preferably 0.015 or larger, even more preferably 0.02 or larger, and is preferably less than 0.07, more preferably 0.06 or less, even more preferably 0.05 or less. By regulating the value thereof so as to be larger than 0.01, the glass can be prevented from having a lower hardness than aluminoborosilicate glasses. By regulating the value thereof so as to be less than 0.07, the glass can be prevented from being embrittled by an increase in specific gravity.

In the glass of the present invention, the value of {5.65/(T2-T7.65)}×T2 (expression 1), which is the product obtained by multiplying the viscosity slope from T2 to the softening point (T7.65) by the T2, is preferably 11 or larger, more preferably 11.1 or larger, even more preferably 11.3 or larger. In a case where the value thereof is 11 or larger, an improvement in softening point is attained while maintaining the same melting temperature. It is hence possible to provide a glass which has a high softening point while being prevented from increasing in T2. Namely, the glass which has been regulated so as to have a T2 of 1,850° C. or lower can be made to have a softening point of 850° C. or higher. It may also be possible to make the glass have a T2 of 1,850° C. or lower and a softening point of 800° C. or higher. Consequently, stress relaxation due to a heat treatment performed in chemical strengthening can be reduced. For example, the degree of stress relaxation (degree of stress change) (%) of a chemically strengthened glass, which is determined by dividing the difference in the compressive stress value between strengthening temperatures of 400° C. and 450° C. {CS(450° C.)-CS(400° C.)} by CS(400° C.), can be reduced to not less than −20%.

The glass of the present invention usually has a sheet shape. However, the glass may be either a flat sheet or a glass sheet which has undergone bending. The glass in this embodiment is a glass sheet which has been formed into a flat shape by a known glass forming method such as the float process, fusion process, slot downdraw process, or the like.

The glass of the present invention has such dimensions that the glass can be formed by an existing forming method. Namely, in a case where the float process is used for the forming, a continuous ribbon-shaped glass having the float forming width is obtained. The glass in this embodiment is finally cut into a size suitable for an intended use.

Specifically, the glass is cut into the size of the display of a tablet PC, smartphone, etc., or into the size of window glasses of a building or house. Although the glass in this embodiment has generally been cut into a rectangular shape, the glass may have been cut into other shapes including circular or polygonal shapes without posing a problem. The embodiment includes the glass which has undergone drilling.

The glass of the present invention can be chemically strengthened. A chemical strengthening treatment is explained below.

<Chemical Strengthening Treatment>

A chemical strengthening treatment can be conducted by a conventionally known method. It is preferable that shaping according to applications, e.g., machining such as cutting, edge surface machining, and drilling, should be performed before the chemical strengthening treatment.

In the chemical strengthening treatment, the glass substrate is brought into contact, by immersion or the like, with the melt of a metal salt (e.g., potassium nitrate) containing a metal ion having a large ionic radius (typically, K ion), and metal ions having a small ionic radius (typically, Na ions or Li ions) in the glass substrate are replaced with ions of the metal having larger ionic radius.

The chemical strengthening treatment can be conducted, for example, by immersing the glass sheet for 5 minutes to 20 hours in molten potassium nitrate having a temperature of 300 to 550° C. Optimal ion-exchange conditions may be selected while taking account of the viscosity properties, intended use, and sheet thickness of the glass, tensile stress within the glass, etc.

Examples of the molten salt for performing the ion-exchange treatment include alkali nitrates, alkali sulfates, and alkali chlorides, such as potassium nitrate, potassium sulfate, and potassium chloride. These molten salts may be used alone or in combination of two or more thereof. A sodium-containing salt may be mixed therewith in order to regulate the chemical strengthening properties.

In the present invention, the conditions for the chemical strengthening treatment are not particularly limited, and optimal conditions may be selected while taking account of the properties of the glass, the molten salt, etc.

<Chemically Strengthened Glass>

The chemically strengthened glass (hereinafter referred to also as “chemically strengthened glass of the present invention”) obtained by chemically strengthening the glass of the present invention includes a compressive stress layer formed in the surface thereof by the ion-exchange treatment. The surface compressive stress is preferably 700 MPa or higher, more preferably 800 MPa or higher, even more preferably 850 MPa or higher, especially preferably 950 MPa or higher. So long as the chemically strengthened glass has transparency to light, the surface compressive stress can be measured by utilizing birefringence.

In a case where a flaw having a larger depth than the surface compressive stress layer is formed in the chemically strengthened glass during the use, the flaw leads to glass fracture. It is hence preferable that the depth of the surface compressive stress layer should be large, and the depth thereof is preferably 20 μm or larger, typically 25 m or larger. Meanwhile, in a case where the depth of the surface compressive stress layer is made excessively large, there is a possibility that this glass might fracture spontaneously. Hence, the depth thereof is usually preferably 70 μm or less. However, this does not apply to the case where the CT is purposely lowered, for example, by increasing the sheet thickness or performing two-stage strengthening.

The depth and surface compressive stress value of the surface compressive stress layer of the chemically strengthened glass of the present invention can be measured using a surface stress meter (e.g., FSM-6000, manufactured by Orihara Industrial Co., Ltd.), etc.

It is preferable that the chemically strengthened glass of the present invention should have, in a surface thereof, at least one member selected from the group consisting of sodium ions, silver ions, potassium ions, cesium ions, and rubidium ions. The presence of such ions induces compressive stress in the surface to strengthen the glass extremely. The silver ions present in the surface can impart antibacterial properties.

By chemically strengthening the glass of the present invention, a chemically strengthened glass can be obtained. Examples of products which employ chemically strengthened glasses include the cover glasses of display devices such as digital cameras, cell phones, and PDAs and the glass substrates of displays.

Applications of the chemically strengthened glass of the present invention are not particularly limited. Since the chemically strengthened glass has high mechanical strength, the chemically strengthened glass is suitable for use in portions which are expected to receive shocks due to falling or undergo contact with other substances.

Examples thereof include protection applications in machines or appliances, such as cover glasses for the display parts of cell phones (including multifunctional information terminals such as smartphones), PHSs, PDAs, tablet terminals, notebook type personal computers, game machines, portable music/video players, electronic books, electronic terminals, watches, cameras, or GPSs, the cover glasses of the touch panel operation monitors of these appliances, the cover glasses of cooking utensils such as electronic ovens and toaster ovens, the top plates of, for example, electromagnetic cooking utensils, the cover glasses of instruments such as meters and gages, and glass sheets for the reading parts of copiers, scanners, and the like.

Examples thereof further include: applications such as window glasses for vehicles, ships, airplanes, and the like, the cover glasses of domestic or industrial illuminators, signals, guide lights, and electronic bulletin boards, showcases, and bullet-proof glasses; and applications such as cover glasses for solar cell protection and glass materials for light condensation for heightening the efficiency of power generation of solar cells.

Examples thereof furthermore include applications such as glasses for various mirror-finished surfaces, the base plates of information recording media such as HDDs, and the substrates of information recording media such as CDs, DVDs, and blue-ray disks.

Examples thereof still further include applications such as water tanks, tableware such as dishes and glasses, various cooking utensils such as bottles and chopping boards, the shelves and walls of cupboards or refrigerators, and building materials for roofs, partitions, etc.

Besides being usable in those applications, the chemically strengthened glass produced through a chemical strengthening treatment is most suitable for use as a glass material for displays to be mounted in various image display devices such as liquid-crystal, plasma, and organic-EL display devices.

### Examples

Examples of the present invention are explained below, but the present invention should not be construed as being limited to the following Examples.

### [Production of Glasses and Chemically Strengthened Glasses]

With respect to each of Examples 1 to 13 and Comparative Examples 1 to 5 shown in Table 1, raw materials for glass which were in common use, such as oxides, hydroxides, carbonates, nitrates, etc., were suitably selected, and given amounts thereof were weighed out so as to result in the composition in % by mole shown in the rows SiO₂ to SnO₂ and to result in 900 g in terms of glass amount. Subsequently, the raw materials were mixed together and placed in a platinum crucible, the crucible was introduced into a 1,650° C. resistance heating type electric furnace, in which the mixture was melted, degassed, and homogenized for 4 hours. Each molten glass obtained was poured into a die, held at a temperature of Tg+30° C. for 1 hour, and then cooled to room temperature at a rate of 0.5° C./min, thereby obtaining a glass block. This glass block was cut and polished, and both surfaces thereof were finally mirror-polished to obtain a sheet-shaped glass (glass capable of being chemically strengthened) having a size of 20 mm×20 mm and a thickness of 1 mm. The glass obtained was subjected to an ion-exchange treatment in which the glass was immersed for 6 hours in the melt of 100% KNO₃ having a temperature of 400 to 450° C. Thus, chemically strengthened glasses were obtained.

### [Measurements of Properties]

### (1) Vickers Hardness (Hv)

The Vickers hardness of each chemically strengthened glass (which had undergone ion-exchange treatment including 6-hour immersion in 425° C. melt of 100% KNO₃) was measured with a Vickers hardness meter manufactured by SHIMADZU (MICRO HARDNESS TESTER RHMV-2) in accordance with the test method as provided for in JIS-Z-2244 (2009) (ISO 6507-1, ISO 6507-4, ASTM-E-384) in an ordinary-temperature ordinary-humidity atmosphere (in this case, the glass was held at room temperature of 25° C. and humidity of 60% RH). The measurement was made on ten portions for each Example or Comparative Example, and an average thereof was taken as the Vickers hardness of the sample of the Example or Comparative Example. The Vickers indenter was pressed against the chemically strengthened glass under a load of 0.98 N for 15 seconds. The numeral in each parenthesis in Table 1 is a calculated value. Each calculated value was determined by calculation using a linear regression equation obtained from measured values of Vickers hardness and the glass composition.

### (2) Specific Gravity

A glass mass weighing 10 g and containing no bubbles was examined by the Archimedes method.

### (3) Measurement of Compressive Stress Value and Compressive Stress Layer

The compressive stress value (CS; unit: MPa) and compressive stress layer (t; unit: μm) of each chemically strengthened glass were measured in an ordinary-temperature ordinary-humidity atmosphere with surface stress meter FSM-6000, manufactured by Orihara Industrial Co., Ltd. The numeral in each parenthesis in Table 1 is a calculated value. Each calculated value was determined by calculation using a linear regression equation obtained from measured values of CS and DOL and from the glass composition.

### (4) Degree of Stress Relaxation (Degree of Stress Change) (%)

The degree of stress relaxation (degree of stress change) of each chemically strengthened glass was determined by measuring the compressive stress values for strengthening temperatures of 400° C. and 450° C. {CS(400° C.) and CS(450° C.)} in the same manner as described above and dividing the difference therebetween {CS(450° C.)-CS(400° C.)} by CS(400° C.).

### (5) High-Temperature Viscosity

The temperature (T2) at which the viscosity was 10² dPa·s and the softening point (T7.65) were measured using a rotary viscometer. The numeral in each parenthesis in Table 1 is a calculated value. Each calculated value was determined by calculation using a linear regression equation obtained from the measured values of T2 and T7.65 and from the glass composition.

TABLE 1

| | Example | Example | Example | Example | Example | Example | Example | Example | Example |
|---|---|---|---|---|---|---|---|---|---|
| (mol %) | 1 | 2 | 3 | 4 | 5 | 6 | 7 | 8 | 9 |
| SiO₂ | 67.0 | 66.1 | 61.2 | 64.4 | 64.5 | 65.5 | 67.0 | 63.4 | 70.0 |
| B₂O₃ | 5.0 | 4.0 | 8.1 | 6.7 | 3.0 | 9.0 | 3.3 | 7.7 | 5.0 |
| Al₂O₃ | 13.0 | 13.9 | 15.0 | 14.0 | 14.0 | 11.0 | 11.9 | 14.5 | 11.0 |
| Li₂O | | | | | | | | | |
| Na₂O | 14.0 | 14.0 | 15.0 | 14.0 | 17.0 | 11.3 | 14.9 | 13.1 | 13.0 |
| K₂O | | | | | | 1.5 | | | |
| MgO | | 1.5 | | | | 0.7 | 0.9 | | |
| CaO | | | | | | 0.3 | | | |
| ZrO₂ | 1.0 | 0.5 | 0.7 | 0.9 | 1.5 | 0.6 | 2.0 | 1.4 | 1.0 |
| SnO₂ | | | | | | | | | |
| ZrO₂/(ZrO₂ + | 0.17 | 0.11 | 0.08 | 0.12 | 0.33 | 0.06 | 0.38 | 0.15 | 0.17 |
| B₂O₃) | | | | | | | | | |
| ZrO₂/(B₂O₃ + | 0.031 | 0.015 | 0.019 | 0.026 | 0.044 | 0.018 | 0.064 | 0.039 | 0.034 |
| Al₂O₃ + | | | | | | | | | |
| R₂O + RO) | | | | | | | | | |
| Hardness | 693 | 676 | 693 | | 749 | | 779 | 696 | 703 |
| (strength- | | | | | | | | | |
| ening) | | | | | | | | | |
| CS(400° C.) | 1143 | 1191 | 1125 | 1106 | 1314 | 930 | 1225 | 1028 | 1007 |
| CS(425° C.) | 1099 | 1164 | 1074 | (1044) | (1230) | (800) | 1205 | | 980 |
| CS(450° C.) | 1063 | 1114 | 978 | 981 | 1152 | 750 | 1134 | 958 | 851 |
| Relaxation % | −7 | −6 | −13 | −11 | −12 | −19 | −7 | −7 | −16 |
| T2 | 1810 | 1795 | 1712 | 1762 | 1776 | (1733) | 1778 | 1736 | 1844 |
| temperature | | | | | | | | | |
| (° C.) | | | | | | | | | |
| T3 | 1569 | 1559 | 1485 | 1531 | 1526 | (1482) | 1537 | 1507 | 1585 |
| temperature | | | | | | | | | |
| (° C.) | | | | | | | | | |
| T4 | 1379 | 1371 | 1306 | 1347 | 1333 | (1317) | 1346 | 1327 | 1382 |
| temperature | | | | | | | | | |
| (° C.) | | | | | | | | | |
| Softening | 938 | 925 | 889 | 902 | 889 | (855) | 895 | 906 | 908 |
| point | | | | | | | | | |
| (T7.65) | | | | | | | | | |
| Expression 1 | 11.7 | 11.7 | 11.8 | 11.6 | 11.3 | 11.2 | 11.4 | 11.8 | 11.1 |
| Specific | 2.40 | 2.41 | 2.39 | 2.39 | 2.46 | (2.37) | 2.44 | 2.42 | 2.38 |
| gravity | | | | | | | | | |
| | Example | Example | Example | Example | Comparative | Comparative | Comparative | Comparative | Comparative |
| (mol % ) | 10 | 11 | 12 | 13 | Example 1 | Example 2 | Example 3 | Example 4 | Example 5 |
| SiO₂ | 65.4 | 59.0 | 68.3 | 67.6 | 64.5 | 65.4 | 64.2 | 68.2 | 68.2 |
| B₂O₃ | 6.0 | 4.5 | 3.0 | 4.0 | 5.1 | 9.0 | 1.0 | 13.6 | 10.2 |
| Al₂O₃ | 12.9 | 16.0 | 13.0 | 11.0 | 14.4 | 10.8 | 8.9 | 4.5 | 3.4 |
| Li₂O | | | | | | 3.7 | | | |
| Na₂O | 12.9 | 17.0 | 15.0 | 13.0 | 13.7 | 7.7 | 13.4 | 9.1 | 13.6 |
| K₂O | 0.5 | | | | | 1.8 | 4.3 | | |
| MgO | 1.2 | 2.3 | 3.0 | 2.3 | 0.7 | 3.7 | | | |
| CaO | 0.5 | | | | | 0.3 | 1.6 | | |
| ZrO₂ | 0.6 | 1.2 | 0.7 | 1.4 | | 0.4 | 2.0 | 4.5 | 4.5 |
| SnO₂ | | | | | | 0.3 | 0.3 | | |
| ZrO₂/(ZrO₂ + | 0.09 | 0.21 | 0.19 | 0.26 | 0.00 | 0.04 | 0.67 | 0.25 | 0.31 |
| B₂O₃) | | | | | | | | | |
| ZrO₂/(B₂O₃ + | 0.018 | 0.030 | 0.023 | 0.045 | 0.000 | 0.012 | 0.061 | 0.167 | 0.167 |
| Al₂O₃ + | | | | | | | | | |
| R₂O + RO) | | | | | | | | | |
| Hardness | 676 | 763 | 681 | 721 | 657 | (650) | | | |
| (strength- | | | | | | | | | |
| ening) | | | | | | | | | |
| CS(400° C.) | 1018 | 1372 | 1174 | 1200 | 1155 | (800) | | 1051 | 1154 |
| CS(425° C.) | 1114 | 1384 | 1038 | 1191 | 1086 | (600) | | (730) | (980) |
| CS(450° C.) | 932 | 1253 | 1058 | 1086 | 1003 | (520) | | (488) | (863) |
| Relaxation % | −8 | −9 | −10 | −9 | −13 | −35 | | −54 | −25 |
| T2 | 1773 | 1528 | 1846 | 1775 | 1751 | (1670) | (1626) | (1646) | (1581) |
| temperature | | | | | | | | | |
| (° C.) | | | | | | | | | |
| T3 | 1528 | 1325 | 1596 | 1522 | 1512 | (1440) | (1392) | | |
| temperature | | | | | | | | | |
| (° C.) | | | | | | | | | |
| T4 | 1336 | 1171 | 1399 | 1329 | 1319 | (1305) | (1246) | (1120) | (1079) |
| temperature | | | | | | | | | |
| (° C.) | | | | | | | | | |
| Softening | 889 | 829 | 931 | 893 | (854) | 743 | 816 | (730) | (700) |
| point | | | | | | | | | |
| (T7.65) | | | | | | | | | |
| Expression 1 | 11.3 | 12.4 | 11.4 | 11.4 | 11.0 | 10.2 | 11.3 | 10.2 | 10.1 |
| Specific | 2.39 | 2.45 | 2.39 | 2.42 | 2.39 | 2.38 | 2.53 | 2.35 | 2.45 |
| gravity | | | | | | | | | |

The following can be seen from the results shown in Table 1.

In Examples 1 to 13, the aluminoborosilicate glasses each had a softening point as high as 800° C. or more and showed a degree of stress relaxation (degree of stress change) of −20% or more, since these glasses each contained, as represented by mole percentage based on oxides, 3% or more and 20% or less of B₂O₃, 8% or more and 20% or less of Al₂O₃, and 0.1% or more and 8% or less of ZrO₂ and contained substantially no Li₂O. Furthermore, the chemically strengthened glasses each showed a hardness as high as 670 or more and a specific gravity of less than 2.48.

Meanwhile, in Comparative Example 3, the content of B₂O₃ was 1.0%, which is not more than 3%. In this case, the chemically strengthened glass had a specific gravity as high as 2.53, which is not less than 2.48. In Comparative Example 2, the content of Li₂O was 3.7%, that is, the glass contained Li₂O. Furthermore, in Comparative Examples 4 and 5, the contents of Al₂O₃ were 4.5% and 3.4%, respectively, which are not more than 8%. In these cases, the glasses each had a low softening point and showed a degree of stress relaxation (degree of stress change) of −20% or less.

It was thus found that by configuring an aluminoborosilicate glass so that the glass contains, as represented by mole percentage based on oxides, 3% or more and 20% or less of B₂O₃, 8% or more and 20% or less of Al₂O₃, and 0.1% or more and 8% or less of ZrO₂ and contains substantially no Li₂O, this aluminoborosilicate glass is inhibited from having an increased specific gravity and from suffering a decrease in surface compressive stress (CS) due to stress relaxation.

In Examples 1 to 13, the values of ZrO₂/(B₂O₃+ZrO₂) were all in the range of 0.05 to 0.45. In these cases, the chemically strengthened glasses each showed a hardness as high as 670 or more. These chemically strengthened glasses each had a specific gravity less than 2.48 and showed mitigated brittleness.

Meanwhile, in Comparative Example 1, the value of ZrO₂/(B₂O₃+ZrO₂) was 0, which is not in the range of 0.05 to 0.45. In this case, the chemically strengthened glass had a hardness of 657, which is less than 670. Namely, this chemically strengthened glass showed a lower hardness value than in the Examples.

In Comparative Example 3, the value of ZrO₂/(B₂O₃+ZrO₂) was 0.67, which is not in the range of 0.05 to 0.45. In this case, the chemically strengthened glass had a specific gravity of 2.53, which is higher than 2.48. No mitigation of brittleness was observed.

It was thus found that in a case where the value of ZrO₂/(B₂O₃+ZrO₂) is in the range of 0.05 to 0.45, a chemically strengthened glass having both of low brittleness and high hardness is rendered possible.

In Examples 1 to 13, the values of ZrO₂/(B₂O₃+R₂O+R′O+Al₂O₃) were all in the range of 0.01 to 0.07. In these Examples, the chemically strengthened glasses each showed a hardness as high as 670 or more. These chemically strengthened glasses each had a specific gravity of less than 2.48 and showed mitigated brittleness.

Meanwhile, in Comparative Example 1, the value of ZrO₂/(B₂O₃+R₂O+R′O+Al₂O₃) was 0, which is not in the range of 0.01 to 0.07. In this case, the chemically strengthened glass had a hardness of 657, which is less than 670. Namely, this chemically strengthened glass showed a lower hardness value than in the Examples.

It was thus found that in a case where the value of ZrO₂/(B₂O₃+R₂O+R′O+Al₂O₃) is in the range of 0.01 to 0.07, a chemically strengthened glass having both of low brittleness and high hardness is rendered possible.

In Examples 1 to 13, the values of {5.65/(T2-T7.65)}×T2 were all 11 or larger. In these Examples, the chemically strengthened glasses each showed a softening point as high as 800° C. or more. In these Examples, the glasses each showed a degree of stress relaxation (degree of stress change) for strengthening temperatures of 400° C. and 450° C. of −20% or more (same as the above).

Meanwhile, in Comparative Examples 2, 4, and 5, the values of {5.65/(T2-T7.65)}×T2 were less than 11. In these cases, the chemically strengthened glasses each had a softening point of lower than 800° C. In these cases, the values of the degree of stress relaxation (degree of stress change) for strengthening temperatures of 400° C. and 450° C. were less than −20%.

It was thus found that by configuring an aluminoborosilicate glass so that {5.65/(T2-T7.65)}×T2 is 11 or larger and that the glass contains no Li₂O, the glass can be made to have a softening point of 800° C. or higher when having a T2 not higher than 1,850° C. Namely, it was found that a chemically strengthened glass which has a high softening point and in which the T2 is prevented from being high can be thus provided.

While the present invention has been described in detail and with reference to specific embodiments thereof, it will be apparent to one skilled in the art that various changes and modifications can be made therein without departing from the spirit and scope thereof. This application is based on Japanese patent application No. 2014-094050 filed on Apr. 30, 2014, the entire contents of which are incorporated herein by reference.

1. A glass comprising, as represented by mole percentage based on the following oxides, from 56 to 72% of SiO₂, from 3 to 20% of B₂O₃, from 8 to 20% of Al₂O₃, from 8 to 25% of Na₂O, from 0 to 5% of K₂O, from 0 to 15% of MgO, from 0 to 5% of CaO, from 0 to 3% of SrO, from 0 to 3% of BaO, and from 0.1 to 8% of ZrO₂ and containing substantially no Li₂O.

2. The glass according to claim 1, wherein the following relationship using contents of respective components is satisfied: 0.05<ZrO₂/(B₂O₃+ZrO₂)<0.45.

3. The glass according to claim 1, wherein the following relationship using contents of respective components is satisfied: 0.01<ZrO₂/(B₂O₃+R₂O+R′O+Al₂O₃)<0.07 (where R is at least one member selected from the group consisting of Na and K, and R′ is at least one member selected from the group consisting of Mg, Ca, Sr, and Ba).

4. The glass according to claim 1, wherein as viscosity properties of the glass, when a viscosity slope from a temperature (T2) at which the glass has a viscosity of 10² dPa·s to a temperature (softening point: T7.65) at which the glass has a viscosity of 10^{7.65} dPa·s is multiplied by the T2, the resultant product {5.65/(T2-T7.65)}×T2 (expression 1) is 11 or larger, and the T2 is 1,850° C. or lower and the softening point is 800° C. or higher.

5. The glass according to claim 1, which has been produced by a float process.

6. The glass according to claim 1, which can be chemically strengthened.

7. A chemically strengthened glass obtained by chemically strengthening the glass according to claim 6, the chemically strengthened glass having in a surface thereof at least one member selected from the group consisting of a sodium ion, a silver ion, a potassium ion, a cesium ion, and a rubidium ion, and having a surface compressive stress of at least 700 MPa and having a surface compressive stress layer having a depth of at least 20 μm.

8. The chemically strengthened glass according to claim 7, which has a specific gravity of less than 2.48.

9. A cover glass comprising the chemically strengthened glass according to claim 7.

10. A display device comprising the cover glass according to claim 9.

11. A touch panel comprising a glass substrate on which an electrode for detecting an input position has been formed, the glass substrate comprising the chemically strengthened glass according to claim 7.

12. A touch panel comprising a glass substrate on which an electrode for detecting an input position has been formed, the glass substrate comprising the cover glass according to claim 9.
